(19) United States
(12) Patent Application Publication
(10) Pub. No.: US 2003/0152818 A1
(43) Pub. Date: Aug. 14, 2003

(54) Method for separating carbon dioxide out of a mixture of water and fuel, and corresponding device

(76) Inventor: Walter Preidel, Erlangen (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/368,078

(22) Filed: Feb. 18, 2003

Related U.S. Application Data
(63) Continuation of application No. PCT/DE01/02905, filed on Jul. 31, 2001.

(30) Foreign Application Priority Data
Aug. 16, 2000 (DE) 100 40 086.8

(51) Int. Cl. H01M 8/10

(52) U.S. Cl. 429/30; 429/33

(57) ABSTRACT

Carbon dioxide is removed from a water/fuel mixture, especially in a fuel cell. To this end, a separation installation that works according to the principle of the fuel cell is used for removing the carbon dioxide with the help of a fuel- and water-permeable membrane. The corresponding device has a fuel cell unit that is used as the separation installation and that forms part of the entire installation.

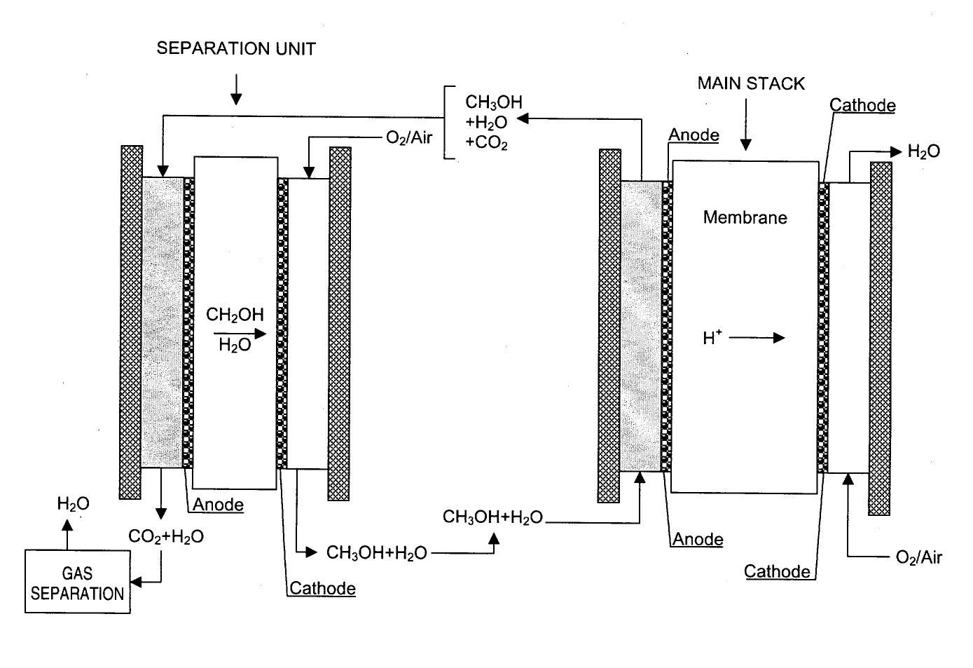

### CROSS-REFERENCE TO RELATED APPLICATION

This application is a continuation of copending International Application No. PCT/DE01/02905, filed Jul. 31, 2001, which designated the United States and which was not published in English.

### BACKGROUND OF THE INVENTION

### FIELD OF THE INVENTION

The invention relates to a method for separating carbon dioxide out of a mixture of water and fuel, in particular out of a water/fuel mixture that is present in a fuel cell. In addition, the invention also relates to a device that is configured for carrying out the method, having a separation unit for separating carbon dioxide out of a water/fuel mixture. In the invention, the fuel is preferably, but not exclusively, methanol.

Fuel cells are operated with liquid or gaseous fuels. If the fuel cell operates with hydrogen, a hydrogen infrastructure or a reformer for generating the gaseous hydrogen from the liquid fuel is required. Examples of liquid fuels are gasoline, ethanol, and methanol. A so-called DMFC (“Direct Methanol Fuel Cell”) operates directly with methanol as its fuel. The function and status of the DMFCs are described in detail in “VIK-Berichte”, No. 214 (Nov. 1999), pages 55-62.

The separation of carbon dioxide out of a mixture of water and methanol is a significant problem in connection with the circulation of the anode liquid in the methanol-operated fuel cell. The gaseous carbon dioxide needs to be separated from the liquid methanol/water mixture at the highest possible temperature—if possible the operating temperature of the fuel cell. The highest possible temperature is desirable since the solubility of carbon dioxide decreases as the temperature rises and the effort for cooling the liquid mixture is not required, but rather simply reduces the efficiency of the overall system. However, since the carbon dioxide expels a large quantity of methanol without additional cooling, which is accounted for by the high methanol partial pressure (boiling point Tₛ=65° C.), additional cooling of the liquid mixture is required.

In the prior art, the liquid/gas mixture is cooled to well below the boiling point of methanol, the carbon dioxide is passed to an active surface to bubble out and then the liquid-gas mixture is separated in a vessel. Therefore, in the gas chamber there is fundamentally always a quantity of gaseous methanol which, at the prevailing temperature, is given by the partial pressure of the methanol and the ratio of partial pressure to total pressure. Consequently, however, valuable fuel is discharged from the fuel cell system without being utilized and, if it is not converted into carbon dioxide and water with additional air at a catalytic converter by catalytic combustion, this fuel is discharged into the environment. Emissions of methanol are subject to corresponding regulations, such as those imposed on internal combustion engines, and therefore have to be included in the overall level of hydrocarbons.

### SUMMARY OF THE INVENTION

It is accordingly an object of the invention to provide a method for separating carbon dioxide out of a mixture of water and fuel, and corresponding device which overcomes the abovementioned disadvantages of the heretofore-known devices and methods of this general type and which improves the separation of carbon dioxide out of a water/fuel mixture, as well as an associated device that improves the process.

With the foregoing and other objects in view there is provided, in accordance with the invention, a method of separating carbon dioxide out of a mixture of water and fuel, which comprises:

conducting a mixture of water and fuel into a separation unit operating according to the principle of a fuel cell with an anode and a cathode; and

separating carbon dioxide out of the mixture of water and fuel.

In accordance with an added feature of the invention, the water/fuel mixture originates from a fuel cell.

In accordance with a preferred embodiment, the fuel is methanol.

In accordance with an additional feature of the invention, the methanol is conveyed to the cathode of the separation together with the water, and a carbon dioxide-enriched liquid remains as an anode liquid.

In accordance with another feature of the invention, the anode liquid is conducted through a membrane.

In accordance with a further feature of the invention, the carbon dioxide enriched liquid remaining at the anode of the separation unit is separated into gas and water in a gas separator.

In accordance with again a further feature of the invention, the anode liquid is recirculated and the cathode liquid at the separator is recovered as a water/methanol mixture.

With the above and other objects in view there is also provided, in accordance with the invention, a device for separating carbon dioxide out of a mixture of water and fuel,comprising:

an inlet for receiving a water/methanol mixture;

a separation unit receiving the water/methanol mixture from said inlet and separating carbon dioxide out of the water/methanol mixture, said separation unit having an anode and a cathode and operating according to the principle of a fuel cell.

In accordance with again an added feature of the invention, the separation unit is a fuel cell with a proton-conducting membrane. In a preferred embodiment, the proton-conducting membrane has an equivalent weight of less than 120, preferably less 110.

In accordance with a concomitant feature of the invention, the membrane consists of a material based on polyperfluoroalkylsulfonic acid.

In sum, the invention uses a separation unit which operates according to the principle of the fuel cell for the separation. The loss of fuel, which is generally considered a drawback and a disadvantage in current fuel cells, with the fuel-permeable and water-permeable membrane in a fuel cell, is rendered an advantage with the invention.

Other features which are considered as characteristic for the invention are set forth in the appended claims.

Although the invention is illustrated and described herein as embodied in a method for separating carbon dioxide out of a mixture of water and fuel, and corresponding device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of a specific exemplary embodiment.

### BRIEF DESCRIPTION OF THE DRAWING

The single figure is a schematic diagram illustrating an assembly according to the invention with a main stack (illustrated as a single cell) and a separation unit.

### DESCRIPTION OF THE PREFERRED EMBODIMENT

Referring now to the sole figure of the drawing in detail, there is shown a stack on the right-hand side that corresponds to the prior art. There, methanol (CH₃OH) and water (H₂O) is provided as a fuel/water mixture into the anode. The generic reaction causes the methanol to be burned up and for hydrogen ions to traverse the membrane to the cathode. The cathode side of the fuel cell stack, which is supplied with air, outputs water.

While the invention is described in detail with reference to a DMFC (direct methanol fuel cell), wherein the fuel used is methanol, it will be understood that this is but an exemplary embodiment and that the invention is not limited to the specific embodiment.

The anode side, following the anode reaction in the stack, outputs a mixture of water, carbon dioxide, and methanol. The anode output mixture is supplied to a separation unit according to the invention, illustrated on the left-hand side.

A primarily important part of a fuel cell is the membrane electrolyte assembly (MEA), which has a specific methanolpermeable and water-permeable membrane, which is chemically described as polyperfluoroalkylsulfonic acid. A membrane of this type is available under the trade name Nafion® (E.I. DuPont de Nemours). Nafion® membranes are usually wherein by their equivalent weight, the membrane referred to as the Nafion 117 membrane usually being used especially in DMFC fuel cells. These membranes are rendered hydrophobic for use in the fuel cell.

It is now provided that the anode liquid in this method according to the invention be passed through a further cell or further cells with a Nafion membrane, which may also be thinner than the standard Nafion 117 membrane i.e. Nafion 115 or Nafion 112. Nafion material with a lower equivalent weight i.e. 105 or 102, is also conceivable.

The lower the resistance of the additional cell, the lower the outlay required for the separation. The anode liquid, after it has run through the anodes, is passed into this cell or the additional unit of cells in the case of relatively large stacks, and operation is carried out at the highest possible current densities.

Like the stack, the cathode is supplied with air, and consequently the cell itself is responsible for the current flux. The high current densities mean that electroosmosis is particularly pronounced and the methanol is delivered to the cathode together with the water. Then, a carbon dioxide-enriched liquid remains at the anode. In this way, the carbon dioxide is completely separated from the liquid which is carried to the cathode. The liquid obtained in this way can then be used again in the anode circuit of the stack. The remaining liquid at the anode of the separation unit, which has an enriched level of carbon dioxide, can in this way be separated more easily into gas and water in a gas separator, illustrated in the bottom left-hand corner of the drawing figure. The anode liquid can circulate in this additional unit, and the cathode liquid which is formed is recovered as a water/methanol mixture. The cell voltage should be as low as possible and the current density should be as high as possible, so that the demand for energy for the electro-osmosis is as low as possible.

The method described is particularly advantageous if a membrane which is significantly less methanol-permeable and water-permeable than the Nafion membrane in the exchanger is used in a DMFC fuel cell. It is then also possible to use proton-conducting membranes other than Nafion in the separation unit.

In the case of the device according to the invention, therefore, what is currently the significant drawback of DMFCs, namely the excessively permeable membrane, is turned into an advantage. A device of this type can be used directly in a fuel cell system as an additional unit or cell configuration.

The solution to the problem of separating carbon dioxide out of the water/fuel mixture which has been described above on the basis of a DMFC which is operated with methanol as fuel can also be transferred to fuel cells which are operated with other fuels.

I claim:

1. A method of separating carbon dioxide out of a mixture of water and fuel, which comprises:
conducting a mixture of water and fuel into a separation unit operating according to the principle of a fuel cell with an anode and a cathode; and
separating carbon dioxide out of the mixture of water and fuel.

2. The method according to claim 1, which comprises conducting a water/fuel mixture from a fuel cell to the separation unit.

3. The method according to claim 1, wherein the fuel is methanol.

4. The method according to claim 3, which comprises conveying the methanol to the cathode together with the water, wherein a carbon dioxide-enriched liquid remains as an anode liquid.

5. The method according to claim 4, which comprises passing the anode liquid through a membrane.

6. The method according to claim 5, which comprises separating the carbon dioxide enriched liquid remaining at the anode of the separation unit into gas and water in a gas separator.

7. The method according to claim 1, which comprises circulating the anode liquid and recovering a cathode liquid as a water/methanol mixture.

8. A device for separating carbon dioxide out of a mixture of water and fuel, comprising:
an inlet for receiving a water/methanol mixture;
a separation unit receiving the water/methanol mixture from said inlet and separating carbon dioxide out of the water/methanol mixture, said separation unit having an anode and a cathode and operating according to the principle of a fuel cell.

9. The device according to claim 8, wherein said separation unit is a fuel cell having a proton-conducting membrane.

10. The device according to claim 9, wherein said proton-conducting membrane has an equivalent weight of less than 120.

11. The device according to claim 9, wherein said proton-conducting membrane has an equivalent weight of less than 110.

12. The device according to claim 9, wherein said membrane consists of a material based on polyperfluoroalkylsulfonic acid.
